(19) United States
(12) Patent Application Publication
(10) Pub. No.: US 2018/0207980 A1
(43) Pub. Date: Jul. 26, 2018

(54) LIGHTWEIGHT HUB MADE OF ALUMINUM-STEEL COMPOSITE MATERIALS

(71) Applicant: LTW Technology (Tianjin) Co.Ltd, Wuqing (CN)

(72) Inventor: Jianhua DONG, Wuqing (CN)

(73) Assignee: LTW Technology (Tianjin) Co.Ltd, Wuqing (CN)

(21) Appl. No.: 15/746,117

(22) PCT Filed: Jul. 21, 2016
(86) PCT No.: PCT/CN2016/090934

§ 371 Date: Jan. 19, 2018

(30) Foreign Application Priority Data
Jul. 21, 2015 (CN) 201520532507.1

(51) Int. Cl. B60B 27/02; B60B 27/00

(52) U.S. Cl. CPC B60B 27/02; B60B 27/0052; B60B 27/0057; B60B 27/0078; B60B 2380/90; B60B 2360/104; B60B 2320/10; B60B 2310/204; B60B 2900/111; B60B 2900/112; B60B 2900/113; B60B 2900/311; B60B 2360/102

(57) ABSTRACT

The utility model relates to the technical field of a hub, particularly to a light-weight hub made of a steel-aluminum composite material. The hub includes an aluminum alloy base body, an outer bearing hole steel sleeve, an inner bearing hole steel sleeve and a plurality of bolt hole steel inserts; wherein a plurality of wheel bolt holes and brake disc bolt holes in a circumferential side of a flange of the aluminum alloy base body are provided with steel inserts; and an outer bearing outer race and an inner bearing outer race are respectively press-fitted into the outer bearing steel sleeve and the inner bearing steel sleeve in an interference manner, so as to be fixedly connected with the hub.

### TECHNICAL FIELD

The utility model relates to the technical field of a hub, particularly to a lightweight hub made of a steel-aluminum composite material.

### BACKGROUND

As science and society have advanced, low-carbon green has been the theme. Low cost, low energy consumption and low pollution are achieved by applying new technologies, new processes and new materials, light weight of product components coincides with this trend, is required by development of enterprises themselves, and is the social duty and responsibility to be obliged by the enterprises. A hub is an important part of a moving machine. The lightweight hub may reduce the moving mass, decrease the rotational inertia, reduce the operational resistance, and effectively improve the mechanical transmission efficiency. The hub in the prior art is mostly made of a cast iron alloy or structural alloy steel or molded from a single lightweight material. However, two kinds of hubs have the following defects, particularly:

a traditional hub made of a cast iron alloy or structural alloy steel:

in an axle, the hub is connected with a half shaft, a wheel and a brake drum to transmit a driving and braking force and a moment. Such a use function requires the hub to have relatively high strength, rigidity and toughness. Therefore, traditionally, the hub is made of a material with relatively high strength and toughness, such as ductile iron QT450-5, 42CrMo structural alloy steel and the like. A molding method mainly includes casting and forging. Compared with hubs made of light alloy materials or ferrous alloy materials, the hub is high in melting temperature, high in energy consumption, difficult in cutting and high in treatment cost in a production process. In a use process, due to high density and large weight, the driving energy consumption is high, and energy conversation and emission reduction are not facilitated. A weight reduction ratio achieved by performing a finite element lightweight structure optimization design on an existing hub made of the ferrous alloy material is limited, which does generally not exceed 10%, and may not meet a requirement of light weight of the complete vehicle for parts according to higher and higher energy consumption and emission regulations; and

a hub mold from a single lightweight material:

For the above deficiencies of the cast iron alloy and the steel, some lightweight materials with relatively low density are used to manufacture the hub, such as an aluminum alloy, a magnesium alloy and a polymer. Molding processes include sand casting, metal mould high-pressure casting, gravity or low-pressure casting, forging and thermoforming. With the aluminum alloy as an example, its density and elastic modulus are about one-third of those of a steel material, so that a greater volume of the aluminum alloy must be used to meet requirements of the product for stiffness and strength, the weight reduction ratio does generally not exceed 40%; and meanwhile, the aluminum alloy has some insurmountable shortcomings, such as low yield strength, large thermal expansion coefficient, significant heat fading, and the like, which may not reliably meet use requirements, such that popularization and application of the hub made of the aluminum alloy are limited.

### SUMMARY

In order to effectively solve the above problems, the utility model provides a lightweight hub made of a steel-aluminum composite material.

Particularly, a technical solution of the lightweight hub made of a steel-aluminum composite material is as follows.

The lightweight hub made of a steel-aluminum composite material is entirely made of steel and an aluminum alloy, and is applied in a chassis of a land wheeled vehicle.

Further, the hub includes an aluminum alloy base body, an outer bearing hole steel sleeve, an inner bearing hole steel sleeve, an outer bearing outer race, an inner bearing outer race and a plurality of bolt hole steel inserts; wherein the outer bearing outer race and the inner bearing outer race are respectively press-fitted into the outer bearing hole steel sleeve and the inner bearing hole steel sleeve in an interference manner, so as to be fixedly connected with the hub; a plurality of bolt holes on circumferential side of a flange of the aluminum alloy base body are provided with bolt hole steel inserts, bolt hole steel inserts are provided around circumferential sides of the bolt holes, end faces of the steel inserts are exposed on a flange surface of the aluminum alloy base body so as to be in direct contact with bolt heads or other fastening connectors.

Further, wheel bolts penetrate through wheel bolt hole inserts for fastening a rim and a brake drum on the hub by using wheel nuts, brake disc bolts penetrate through brake disc bolt hole inserts for fastening a brake disc on the hub; and an end face gear ring of a brake acceleration sensor is mounted on the hub.

Further, the outer bearing hole steel sleeve is made of a material with the same thermal expansion coefficient as that of the outer bearing outer race, and the inner bearing hole steel sleeve is made of a material with the same thermal expansion coefficient as that of the inner bearing outer race.

Further, the aluminum alloy hub is provided with bearing outer race bushings on the bearing outer races.

Further, a plurality of inserts made of a high-strength material are provided on circumferential sides of the bolt holes, the inserts are in direct contact with fastening bolts and nuts, and the bushings and the plurality of inserts are provided independently.

Further, threaded grooves, trenches or planes are provided on both the bushings and the inserts.

Further, the wheel bolts penetrate through the wheel bolt hole inserts for connecting the rim and the brake drum onto the hub, and are fastened by using the wheel nuts.

Further, both the bushings and the inserts are cast-molded from ductile iron or steel.

The utility model may achieve the following technical effects:

light weight, namely, in comparison with a ferrous metal, a weight reduction ratio is more than 50%;

high strength, namely, in comparison with a lightweight material such as an aluminum alloy, a local yield strength is increased from 206 Mpa to 353 Mpa or more, which is increased by 30%, while there still remains a relatively large process adjustment range;

wide technical range, namely, a molding process is suitable for all structural shapes of hubs; and

low cost, namely, in comparison with the entire adoption of a high-strength aluminum alloy, the cost is lowered.

### BRIEF DESCRIPTION OF THE DRAWINGS

FIG. 1 is a schematic cross-sectional diagram showing a structure of the utility model (a lightweight hub made of a steel-aluminum composite material), and

FIG. 2 is schematic diagram showing an assembly structure of the utility model in a rim component.

### DETAILED DESCRIPTION

Objectives, technical solutions and advantages of the utility model will become more apparent from the following detailed description of the utility model when taken in conjunction with accompanying drawings and embodiments. It should be understood that specific embodiments described herein are merely illustrative of the utility model and are not intended to limit the utility model.

Rather, the utility model encompasses any alternatives, modifications, equivalent methods, and solutions made within the spirit and scope of the utility model as defined by the claims. Further, in order to give the public a better understanding of the utility model, some specific details are described below in detail in the following detailed description of the utility model. It will be appreciated by those skilled in the art that the utility model may be understood without reference to the details.

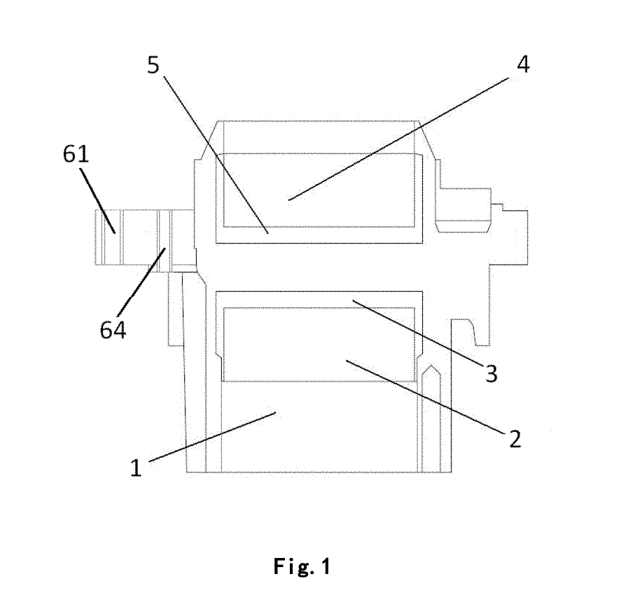

The utility model provides a lightweight hub made of a bimetallic material. As shown in FIG. 1, the lightweight hub made of a bimetallic material includes a hub body 1, wherein the hub body 1 is an aluminum alloy base body and is integrally formed from an aluminum alloy to achieve light weight of a hub of an axle of a land wheeled vehicle.

An outer bearing hole bushing 3 and an inner bearing hole bushing 5 as well as a plurality of bolt hole inserts 61, 64 are fixedly connected with the hub body 1 by means of a low-pressure or gravity cast-molding process.

An outer bearing outer race 2 and an inner bearing outer race 4 are parts of a bearing standard component, are provided by the special bearing manufacturer, and are generally made of carbon alloy steel; and the outer bearing outer race 2 and the inner bearing outer race 4 are respectively assembled into the outer bearing bore bushing 3 and the inner bearing bore bushing 5 in an interference fit manner, so as to achieve a rotational connection of the lightweight hub with an axle housing.

A thermal expansion coefficient of the aluminum alloy is about 2 times of that of the carbon alloy steel. If the bearing outer races are directly press-fitted into aluminum alloy holes in an interference manner, when a working temperature changes, the interference amount will be decreased or increased, resulting in a phenomenon of oversized holding force and loose fit, and even in a failure of “bearing hole cracks” or “bearing outer race rejection”. By providing the bushing 3 and the bushing 5 with the same or similar thermal expansion coefficient as that of the bearing outer race in the bearing holes, the transition between thermal expansion properties of the two materials is achieved, and the problem of inconsistent thermal deformation of a matching surface between the bearing outer races and bearing mounting holes due to a large difference in the thermal expansion coefficients is solved. When the working temperature changes, the utility model maintains a mating relationship of an original design mating pair unchanged, and solves the problems in design, process and use of a change in a pretightening force and the like due to “rejection”, “temperature-difference assembly” and “change in interference amount”.

Furthermore, the bushings and the inserts (the inner bearing hole bushing 3, the outer bearing hole bushing 5 as well as the plurality of inserts) employ special structures and manufacturing processes, particularly helical grooves, trenches and planes, as well as special dissimilar material transitional-connection process, to activate a material base body to more effectively bond the ductile iron and a bonding surface of steel and the aluminum alloy by means of a physical method and a chemical method.

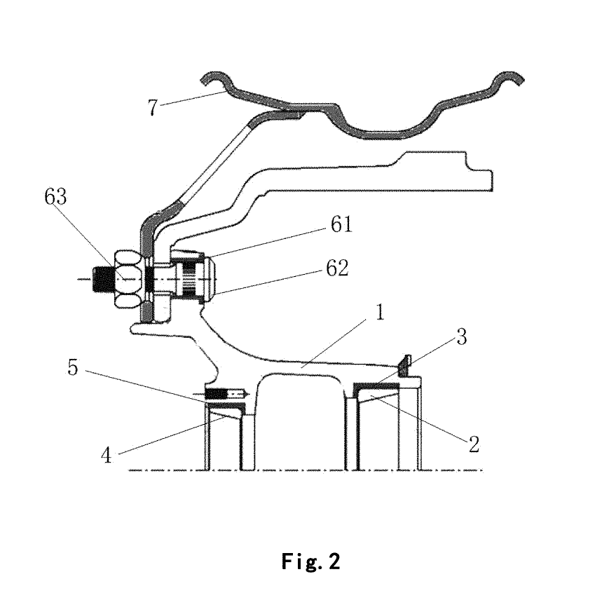

As shown in FIG. 2, bolt holes 6 are uniformly provided in an outer circumferential side of the hub body 1, bolt hole inserts 61 are provided on circumferential sides of the bolt holes 6, wheel bolts 62 penetrate through wheel bolt hole inserts 61 for connecting a rim 7 and a brake drum 8 onto the hub, and are fastened by using wheel nuts 63; and the bolt hole inserts 61 are made of ductile iron or steel with relatively high yield strength for being in direct contact with the wheel bolts 62 and the wheel nuts and other fastening connectors, in order to improve the local crushing strength of the hub.

The utility model solves the problem of light weight of the hub of the vehicle, which is reduced by more than 50% in comparison with the ferrous metal; solves the problem of the cost of the lightweight hub, which is lowered when the hub is made of a common aluminum alloy in comparison with a hub integrally made of a single high-strength high-performance aluminum alloy; and solves the problem of inconsistent thermal deformation due to different thermal expansion coefficients of two materials when bearing outer races made of the carbon alloy steel are directly assembled into bearing holes made of the aluminum alloy. Particularly, as the working temperature is decreased (or increased), the interference amount of the bearing outer races is increased (or decreased), which causes problems that the bearing holes made of the aluminum alloy are crushed to form cracks, or a bearing is seized, or the bearing outer races radially loosen and slide. The problem of poor assembly manufacturability of the entire hub made of the aluminum alloy is solved. Since the entire hub made of the aluminum alloy needs a large interference amount when the bearing outer races are assembled, it is necessary to press the heated bearing holes of the hub after the bearing outer races are frozen, resulting in poor assembly operation manufacturability. However, a preset bushings of the bearing outer races adopted in the utility model are assembled with a normal interference amount at a room temperature, so good operation manufacturability is achieved. The problem of insufficient crushing strength of a common hub made of the aluminum alloy is solved, a plurality of inserts made of a high-strength material are provided on the circumferential sides of a plurality of (20) bolt holes so as to be in direct contact with fastening bolts and nuts, so that the local crushing strength of the hub made of the aluminum alloy is improved. Two independent inner and outer bushings and a plurality of (20) inserts are provided, so that significant weight reduction effect is realized. The wheel bolts 62 penetrate through the wheel bolt hole inserts 61 for connecting the rim 7 and the brake drum 8 onto the hub, and are fastened by using the wheel nuts 63. Threaded grooves, trenches and planes are provided on the bushings and the inserts. The friction drive of the end faces is compressed by means of bolt connection. The utility model is molded by means of a low-pressure casting or gravity casting process, and is wide in technical range. The bushings and the inserts are cast-molded from the ductile iron or steel. A special dissimilar material transitional-connection treatment process is used to activate the material base body, so that the ductile iron and a bonding surface of the steel and the aluminum alloy are more effectively bonded by means of the physical method and the chemical method.

1-8. (canceled)

9. A lightweight hub made of a steel-aluminum composite material, which is applied in a chassis of a land wheeled vehicle, wherein the hub comprises an aluminum alloy base body, an outer bearing hole steel sleeve, an inner bearing hole steel sleeve, an outer bearing outer race, an inner bearing outer race and a plurality of bolt hole steel inserts; wherein the outer bearing outer race and the inner bearing outer race are respectively press-fitted into the outer bearing hole steel sleeve and the inner bearing hole steel sleeve in an interference manner, so as to be fixedly connected with the hub; and a plurality of bolt holes in a circumferential side of a flange of the aluminum alloy base body are provided with bolt hole steel inserts, bolt hole steel inserts are provided around circumferential sides of the bolt holes, and end faces of the steel inserts are exposed on a flange surface of the aluminum alloy base body so as to be in direct contact with bolt heads or other fastening connectors; wherein the outer bearing hole steel sleeve is made of a material with the same thermal expansion coefficient as that of the outer bearing outer race, and the inner bearing hole steel sleeve is made of a material with the same thermal expansion coefficient as that of the inner bearing outer race.

10. The lightweight hub made of a steel-aluminum composite material according to claim 9, wherein wheel bolts penetrate through wheel bolt hole inserts for fastening a rim and a brake drum on the hub by using wheel nuts; brake disc bolts penetrate through brake disc bolt hole inserts for fastening a brake disc on the hub; and an end face gear ring of a brake acceleration sensor is mounted on the hub.

11. The lightweight hub made of a steel-aluminum composite material according to claim 10, wherein the aluminum alloy hub is provided with bearing outer race bushings on the bearing outer races.

12. The lightweight hub made of a steel-aluminum composite material according to claim 11, wherein a plurality of inserts made of a high-strength material are provided on circumferential sides of the bolt holes, the inserts are in direct contact with fastening bolts and nuts, and the bushings and the plurality of inserts are provided independently.

13. The lightweight hub made of a steel-aluminum composite material according to claim 12, wherein threaded grooves, trenches or planes are provided on both the bushings and the inserts.

14. The lightweight hub made of a steel-aluminum composite material according to claim 13, wherein the wheel bolts penetrate through the wheel bolt hole inserts for connecting the rim and the brake drum onto the hub, and are fastened by using the wheel nuts.

15. The lightweight hub made of a steel-aluminum composite material according to claim 14, wherein both the bushings and the inserts are cast-molded from ductile iron or steel.
